(19) United States
(12) Patent Application Publication
(10) Pub. No.: US 2008/0270884 A1
(43) Pub. Date: Oct. 30, 2008

(54) Data Acquiring Method

(75) Inventor: Klaus Rehm, Syrgenstein (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Claudia Hammer-Rehm, Syrgenstein (DE)

(21) Appl. No.: 12/089,063

(22) PCT Filed: Sep. 25, 2007
(86) PCT No.: PCT/EP2006/009278

§ 371 Date: Apr. 3, 2008

(30) Foreign Application Priority Data
Oct. 6, 2005 (DE) 10 2005 048 600.2

(51) Int. Cl. G06F 17/00; G06F 3/00

(52) U.S. Cl. 715/224; 345/156

(57) ABSTRACT

A method for acquiring data (4) related to a document (2) which is displayed on the screen of a data processing device, wherein the data items (4) of the document (2) are associated to marked document fields (6) and the data items (4) associated in the document fields (6) are recorded in input fields (10) of an input data mask (8). The method includes successively activating the document field groups according to a sequence given by an activation trigger unit and in automatically inputting at least one data item (4), which is associated to the corresponding activated data field group, in the input field (10) of the input data mask (8) activated according to the given sequence.

### BACKGROUND

The invention relates to a method for the acquisition of data, a data processing device, an activation trigger device, a computer program, and a computer program product.

In many companies, a large number of processing and management processes are based on an exchange of information printed on paper. A typical example for this situation is the issuing of an invoice. However, both legal and also organizational hurdles prevent, to a large extent, a conversion of a transmission of invoices printed on paper to a pure exchange of data. This situation is considered objectionable especially by those companies that receive a large number of invoices, because for further internal processing the most important data of all of these invoices must be recorded.

In the scope of manual acquisition, the data is typically typed by hand. Here, values, that is, text or numbers, associated with the data must be read from the paper and input by hand into an input mask. This procedure produces no or only small investment expense for preparing the data input mask. If the number of invoices and/or data to be processed is small, such manual acquisition generates only minimal personnel costs. In addition, the manual acquisition has the advantage that even unstructured data can be reliably recorded. However, the manual acquisition scales rather poorly. For an increasing amount of data and/or invoices, the personnel costs to be calculated also increase accordingly due to assistants or temporary workers. In addition, reading and/or typing errors cause the input of incorrect data.

Alternatively, the data can be acquired by means of automatic text recognition. This automatic text recognition is used, in particular, for a large amount of data, when, e.g., several thousand invoices are to be processed per month. Here, fully automatic, optical text or character recognition, i.e., so-called OCR (Optical Character Recognition) data recognition, is applied. The documents recorded on paper are scanned in and image information read in this way is converted into data, e.g., letters, numbers, images, bar codes, etc. The most difficult step in this procedure is a recognition of the contents, which means that, for an amount of read information that was already converted into words and/or numbers, the relevant data now must be identified. This step corresponds to a selection of a correct input field in an input mask with possibly a large number of input fields. Because this step is very complicated and thus expensive for the fully automatic data recognition, automatic data recognition comes into play only for a very large quantity of equivalent or essentially similar documents.

This procedure usually scales well, because costs arising with an increasing quantity of data increase on a strongly diminishing scale. In addition, a low error rate with high data quality is to be expected. However, fully automatic data acquisition is initially associated with high investment costs. In addition, this procedure is not possible with unstructured data and/or documents with a frequently changing layout. The documents to be processed ideally should have an identical construction and the data presented on the documents ideally should be depicted always at the same positions.

In view of this background, a method with the features of claim 1, a data processing device with the features of claim 11, an activation trigger unit with the features of claim 18, a computer program with the features of claim 23, and a computer program product with the features of claim 24 will be presented.

### SUMMARY

The invention relates to a method for the acquisition of data of a document displayed on a monitor of a data processing device, wherein the data of the document is allocated to marked document fields and wherein the data allocated to the document fields is recorded in input fields of a data input mask. In the method it is provided that each document field group is activated one after the other in a given sequence by means of an activation trigger unit, wherein at least one data unit allocated to each activated document field group is recorded automatically in each input field activated according to the given sequence.

In the method it is provided, in particular, that each document field group is activated in such a way that at least one document field is selected with the activation trigger unit. Here, on the monitor the one or more document fields are highlighted graphically from the rest of the document. In addition, the one or more selected document fields are triggered and thus enabled by the activation trigger unit, which takes place, e.g., through suitable charging or activation of a corresponding module or switch of the activation trigger unit. At the same time as the trigger, the data unit allocated to the one or more document field groups is recorded in the activated input field of the data input mask. For the case that only one data unit from the document field is to be recorded in the input field, the document field group comprises only this one document field. If data is to be recorded into the input field from several document fields, then several document fields are selected with the activation trigger unit and combined to form the document field group, and all of the data allocated to this document field group will be recorded into the activated input field through the trigger. In both cases, an activation of a document field group comprises a selection of at least one document field and a trigger of this field comprises at least one document field. This means that in the scope of the present invention, a document field group can comprise one or more document fields.

Registration or input of the one or more data units allocated to the document field group is performed advantageously in an input field from a number of input fields, which are arranged accordingly within the data input mask of the given sequence accordingly. The input fields can here be arranged clearly in the data input mask under consideration of graphical aspects. The sequence determining the activation and the associated automatic registration can be selected or set in a user-friendly way. Here, this sequence can be given directly according to how the input fields are arranged within the data input mask one under and/or next to the other.

While the method is being performed, within the data input mask only one input field is activated, to which at least one data unit of the currently activated document field group can thus be uniquely allocated. To guarantee uniqueness of such allocation and thus registration of data, it can be provided that each currently activated input field is located in this activated state only until the registration or input of the one or more data unit to be allocated is complete. Then this input field is deactivated and a subsequent input field, which is provided according to the sequence for the registration of at least the next data unit, is activated automatically.

In one conceivable construction, the data input mask can be divided into individual pages, which are arranged one after the other according to the sequence of the activation, wherein an input field is allocated to each of these pages. While the method is being performed, e.g., only the page with the currently activated input field is displayed on a suitable monitor. As soon as the one or more data units are recorded in this input field through activation of the document field group, the page with the next input field appears automatically.

With this invention, automatic text recognition is combined with a manual allocation of data to input fields. Here, the allocation of data to the input fields is linked with an activation of the corresponding document field group by means of the activation trigger unit. Here, at least one document field that is marked and thus highlighted visibly on the monitor is to be controlled and selected in a suitable way, e.g., by means of a cursor, and charged, triggered, and activated through activation of the activation trigger unit.

If, e.g., a computer mouse is used as the activation trigger unit, then this is to be moved in such a way that a pointer or a corresponding arrow (“cursor”) is moved on the monitor to the appropriate document field group based on a movement of the computer mouse according to the given sequence. The activation of the document field group and thus simultaneously a registration of the data unit allocated to at least one of the document field groups is performed in the case of the computer mouse through a single click on the one or more document fields, which is realized, in turn, through corresponding activation of a switch or a button of the computer mouse, e.g., the “left mouse button.” If the document field group to be defined contains several, i.e., at least two document fields, then these are selected together by “holding down” or “locking” a corresponding button, in the case of the computer mouse this would usually be the left mouse button, and are activated together by “releasing” the button and thus recorded in the corresponding input fields. A comparable button can be provided for any type of suitable activation trigger unit.

Obviously, activation trigger units constructed differently can also be used for carrying out the method. For the case that the monitor of the data processing device is touch sensitive and is thus constructed as a so-called “touchscreen,” e.g., a finger of a person operating the data processing device, a suitable, optionally pen-like pointing instrument, or, e.g., an extendable pointing rod can be used as the activation trigger unit. Here, the document field groups are activated by touching the surface of the monitor.

The activation trigger unit can be formed in one possible construction as an essentially fingertip-shaped module, which is to be arranged on a finger and which has a contact element that can be turned on and off. A selection of several document fields to be activated in a document field group can be realized, e.g., in this case only when this contact element touches corresponding document fields on the monitor in a turned-on state, i.e., e.g., in the form of a pressed button. If the contact element is then turned off or the button is “released,” then the appropriate document field group is activated. Another advantage of the switching on and off is the resulting security, so that document field groups can be activated only selectively and not by accident. One advantage of such a fingertip-shaped module is to be seen furthermore in that, e.g., input can also be realized with any finger, on which the activation trigger unit is arranged, by means of a keyboard or another activity can be constructed in a largely unimpaired way.

It is provided that each time only one current input field of the data input mask is activated by means of a focus, so that the one or more data units of the document field group activated by means of the activation trigger unit is recorded automatically in this activated input field and this input field is then deactivated automatically. Then, by means of the data input mask, a next input field of the data input mask is activated automatically according to the given sequence and thus provides for the allocation of a data unit to a document field group to be activated subsequently by means of the activation trigger unit. The focus here involves a functional pointing element. The focus indicates which input field of the data input mask is currently activated. An allocation and thus an associated input of the one or more data units is then possible only in this currently activated input field due to the focus set in terms of function. If the one or more data units are allocated to the current input field, then the focus automatically jumps to the next input field according to the given sequence and this is indicated as the currently activated field. It is also conceivable that the focus can be shifted manually, so that one or more input fields can be selectively omitted.

It can be provided that each document field group must be activated only once. This has the advantage that only one activating action, that is, only one click or contact and trigger is necessary for each document field group. Thus, additional steps, such as allocation of the one or more data units in the currently activated input field, wherein the one or more data units is copied into this input field, as well as the subsequent activation of the next input field, is introduced automatically. Thus no additional measures are to be taken, so that each document can be processed quickly through activation of the corresponding document field groups according to the given sequence.

The sequence, according to which the document field groups are to be activated and thus the data is to be recorded in the input fields, can be defined by an arrangement of the input fields on the data input mask. For example, the input fields can be arranged on the data input mask, e.g., according to a hierarchical division.

By means of the activation trigger unit, at least one document field of the document field group on the document is to be searched according to this given sequence and activated accordingly through selection and trigger.

In one possible construction, the data input mask is displayed on the monitor of the data processing device. Here, this monitor can have at least one screen or a corresponding optical display device. Thus, it is possible that the document, in which the document fields are marked, and the data input mask are displayed or imaged on the same monitor and thus the same screen. It is also conceivable that the monitor of the data processing device has several screens or corresponding optical display devices. In this case, it is possible to display the document and the data input mask separately from each other on different screens.

When the method is being performed, it is possible to recognize data recorded on a document in paper form. Obviously, data recorded on other two-dimensional, flat documents can also be recognized with the method, wherein the data is visibly highlighted on the documents. The data can be recorded on documents in a written form, which comprises figures, numbers, letters, and thus alphanumeric symbols or general characters.

In a preferred construction, data of a document like an invoice is recognized by the method. Thus it is possible to recognize both numbers, e.g., monetary amounts, a delivery date, or other parameters on the invoice, e.g., consumption values, and also information recorded in text form, e.g., receivers or designations for services rendered.

The documents provided, in particular, in paper form are read by a reading device of the data processing device during the execution of the method. Here, a document field is allocated to each data unit and the document is displayed on the monitor with visibly marked document fields. Reading the document can be performed by means of a scanner, that is, a digital scanning device or a camera. Documents that have been read are provided to the monitor for display by means of suitable programs.

For the case that the documents have already been scanned and exist, e.g., in a TIFF or PDF format, the reading of the documents comprises providing these documents to the monitor, wherein the document fields are visibly marked in a suitable way and thus emphasized or highlighted. Thus, image information from the document is converted into digital symbols, which are marked accordingly, with the reading device.

In another construction of the method, for the case that an unforeseeable data unit is allocated to an input field, it can be provided that a correction routine is automatically initiated. That an unforeseeable data unit is allocated can mean that a document field is accidentally activated twice. Such multiple clicking of a document field would be easy to recognize. It can also happen that a data unit with number and/or text contents is accidentally allocated to an activated input field, wherein these contents are not expected for the currently activated input field, to which this data unit was allocated corresponding to the given sequence through activation of the document field group. In this case, this data unit would make no sense for the input field, i.e., the data unit comprises, e.g., a word, although a number is expected for the input field, or vice versa.

When the correction routine is initiated, a corresponding acoustic and/or optical signal can be generated. A corresponding, advantageously visual reference is produced according to the type of error or at a position, wherein this error occurs, e.g., in a document field of the document or an input field of the data input mask. In addition, at least the last performed step, that is, at least the last performed activation of a document field group and the associated allocation of at least one data unit in an input field can be retracted or restored.

In particular, for the case that an error is to be corrected, a data unit can be allocated to each input field by means of a keyboard of the data processing device. A program, which runs with the execution of the method and which is executed on the data processing device, can be halted and thus discontinued at any time if data is to be allocated and thus input by means of the keyboard.

The invention further comprises a data processing device, which has a monitor and also at least one activation trigger unit and which is constructed for recognizing data of a document displayed on the monitor. This data processing device is constructed to allocate the data of the document to marked document fields and to record the data allocated to the document fields in input fields of a document input mask. With the one or more activation trigger unit of the data processing device, each document field group can be activated one after the other in a given sequence, wherein then at least one data unit allocated to each activated document field group is recorded automatically in each input field of the data input mask activated according to the given sequence.

With this data processing device, preferably all of the steps of the method according to the invention can be executed. The data processing device, in particular, an activation of document field groups, is to be operated by hand.

By means of the one or more activation trigger units of the data processing device, a pointer or arrow can be moved on the monitor, wherein it is provided that when the pointer is positioned on the one or more document fields, these one or more document fields are selected. These one or more selected document fields of the document field group can be triggered by charging one or more activation trigger units and in this way the document field group can be activated. Activation of at least one document field comprises a selection of the one or more document fields and a subsequent trigger. In this connection, the one or more activation trigger units can be constructed as a computer mouse, a touch-sensitive surface (touchpad), or a trackball or the like. When the activation trigger unit is charged, the one or more document fields selected by the pointer can be activated by a single click.

In another construction of the invention, the monitor of the data processing device can be touch sensitive. Here, the one or more document fields of each document field group displayed on this monitor can be activated by touching the monitor. Activation is here realized by means of a finger or a correspondingly constructed touch device as the one or more activation trigger units.

It is further conceivable that the one or more activation trigger units can be arranged on a finger and can have a contact element that can be turned on and off. Here, it can be provided that for activating the document field group, the contact element is to be turned on and the document fields of the document field group displayed on the monitor are to be touched together by the contact element and then the document field group comprising the document fields can be activated by turning off the contact element. Accordingly, the contact element is in a turned-on state only during a selection of the document fields. The activation trigger unit is here constructed so that another action can be performed with the finger or a different device can be activated.

When a simple data unit is recognized, which is allocated to a single document field, the document field can be selected through a single touch, i.e., in the case of a computer mouse, by a single “mouse click,” and simultaneously triggered, i.e., activated, whereby the data unit is automatically recorded in a corresponding input field currently made known to be active by a focus and the focus is instantaneously advanced automatically into the next input field corresponding to the sequence.

Turning on the contact element of the activation trigger unit now has the effect that several document fields can be selected for a turned-on contact element and can be recorded in one and the same input field when the contact element is turned off. This means that as long as the contact element is turned on, the focus in the input mask cannot be advanced. Only turning off the contact element causes the focus to advance to the next input field according to the sequence.

In a comparison of the activation trigger unit that can be arranged on a finger with a computer mouse as the activation trigger unit, the turned-on state of the contact element corresponds to the “pressed state” of the left mouse button. As long as the left mouse button is pressed down, several document fields can be marked together and thus selected on the screen with the cursor of the computer mouse. Only when the left mouse button is released, which corresponds to turning off the contact element, is the data of the selected document fields automatically recorded in a correspondingly defined input field.

Furthermore, it is conceivable that when the contact element is turned on, several document fields, which are combined into a document field group and are to be activated together, can be selected individually one after the other, e.g., each through touching the corresponding document fields on the screen with the contact element, and then these selected document fields are recorded in one and the same input field together only when the contact element is turned off. In this way it is possible to activate document fields that are not adjacent to each other together and to record them in a corresponding input field. In this way, document fields possibly lying in-between, which are not to be activated at the time, could be selectively “bypassed.”

The data processing device can have at least one keyboard, which is operated by hand. These one or more keyboards can be operated, e.g., also with any finger, on which the one or more activation trigger units are arranged, in an unimpaired way. The actual activation of the one or more document fields and the associated allocation of the data in a corresponding input field are performed in such a way that the contact element, after this element touches the touch-sensitive monitor in the turned-on state and has selected the one or more document fields to be activated, is turned off, which is the same as “releasing” the left mouse button in the case of a computer mouse.

When the method is performed, if an error should appear, which can mean, e.g., that document field groups have been activated in an incorrect sequence, such errors can be retracted. Here, interruption free operation of the keyboard is possible for correcting the error, without having to remove the activation trigger unit from the finger.

In another construction, the data processing device can have a reading device for reading documents. Here, this reading device is suitable for processing documents that have been read and/or for preparing for a display on the monitor in such a way that the document fields of the document can be displayed in a visibly well marked way on the monitor. The reading provides a unique allocation of one data unit and, in particular, its contents, to each document field, in which this data unit is then arranged graphically.

Document fields or document field groups, which have not yet been activated within the document displayed on the monitor, can be displayed in a different way, for example, by a different color characterizing the document fields than is the case for document fields that have already been activated at least once. If it should be provided that a document field can be activated several times, this can also be emphasized by a corresponding color marking.

Furthermore, the present invention comprises an activation trigger unit.

The activation trigger unit according to the invention can be arranged on a finger and has a contact element that can be turned on and off. The activation trigger unit is constructed in such a way that for activating a region displayed on a monitor of a data processing device, the contact element is to be turned on and the region displayed on the monitor is to be touched by the contact element and selected in this way and to be triggered by turning off the contact element and thus to be activated.

Accordingly, the contact element is in a turned-on state only during a selection of a corresponding region. For the case that the contact element is turned off, the contact element and thus the activation trigger unit are, in contrast, inactive when they touch any object, so that another device could be activated or another action could be executed with the finger. The region that can be activated by the activation trigger unit can involve, e.g., at least one document field or one document field group of a document displayed on the monitor.

Through the advantageous construction of the activation trigger unit, it is possible this does not have to be taken off or removed from the finger for the use of the activation trigger unit for performing the method according to the invention, when, e.g., an activation of document field groups according to a given sequence is to be interrupted and input into the corresponding data processing device is to be performed by means of a keyboard or a computer mouse. Without interruption, other operating and/or input actions can be performed with the finger.

In addition, the activation trigger unit can have a switch for turning on and off the contact element. This switch can be arranged directly on the activation trigger unit arranged on the finger. In addition, the activation trigger unit can have a transmission module, which is constructed for exchanging signals and thus activation commands with the data processing device. The signals can be transmitted via a corresponding line, with which the activation trigger unit is connected to the data processing device, or also wirelessly via radio. In this case, it is possible that the contact element can be turned on and off by a switch, which is arranged outside of the actual activation trigger unit, e.g., on the keyboard of the data processing device.

In addition, it can be provided that the activation trigger unit has an attachment module, by means of which the activation trigger unit can be arranged on the finger and thus can be connected detachably. The contact element and the switch of the activation trigger unit can be arranged directly on the attachment module.

The presented activation trigger unit can be used as an input or activation device for any computer, in particular, for the data processing device according to the invention and/or can be used for performing the method according to the invention.

The invention further relates to a computer program with program coding means, in order to execute all of the steps of the method according to the invention, when the computer program is executed on a computer or a corresponding computational unit, in particular, the data processing device according to the invention.

The computer program product according to the invention with program coding means stored on a computer-readable data carrier is constructed for performing all of the steps of the method according to the invention, when the computer program is executed on a computer or a corresponding computational unit, in particular, the data processing device according to the invention.

The data is allocated to the input fields through manual operation of the activation trigger unit. Through intelligent control of a program, which is constructed for the execution of the method on the data processing device, and through the skilled arrangement of the input fields according to the given sequence, it is achieved that the person can perform the acquisition of a data unit, that is, a word or a number, and the input into the desired input field through a single activation of a document field group allocated to the data unit and/or single activation of at least one document field allocated to the data unit, that is, e.g., through a single mouse click or through a single touch on the monitor. Suitable pre-processing of the image information delivered by the read-in device from the document allows the desired data to be selected and activated through activation of the activation trigger unit, and in this way can be copied automatically into the corresponding input fields.

Through the single activation of the one or more desired document fields, that is, through a single click or a single touch, the data unit allocated to the document field is copied and recorded into the input field that has been made known to be currently activated by a focus. After this input, the focus automatically jumps to the next input field. A user merely has to activate the document field groups in the correct sequence by means of the activation trigger unit.

With the invention it is possible to acquire data of any document. Different image formats containing the data can be processed. Here it is possible to acquire data in any values, e.g., alphanumeric symbols, general symbols, or as characters. The recorded data can be exported in formats such as MS-Access, MS-Excel, XML, or ASCII for data input masks.

Additional advantages and constructions of the invention emerge from the description and the accompanying drawing.

It is understood that the features named above and those still to be explained below can be used not only in the specified combination, but instead also in other combinations or by themselves, without exceeding the scope of the present invention.

### BRIEF DESCRIPTION OF THE DRAWINGS

The invention is shown schematically in the drawing with reference to one embodiment and will be described in detail below with reference to the drawing.

FIG. 1 shows in a schematic diagram a document displayed on a monitor of a data processing device with marked document fields.

FIG. 2 is a schematic diagram an original of the document from FIG. 1 provided in paper form.

FIG. 3 is a schematic diagram a first embodiment of a data input mask.

FIG. 4 is a schematic diagram the document from FIG. 2 and also an expanded embodiment of the data input mask from FIG. 3.

FIG. 5 is a view of a part of the data input mask from FIG. 3 with filled-out input fields.

FIG. 6 is a schematic diagram an embodiment of an activation trigger unit for the execution of a construction of the method according to the invention.

FIG. 7 is a view of the activation trigger unit from FIG. 6 in an enlarged schematic diagram.

### DETAILED DESCRIPTION OF THE PREFERRED EMBODIMENTS

The figures will be described in connection and overall; identical reference symbols designate identical components.

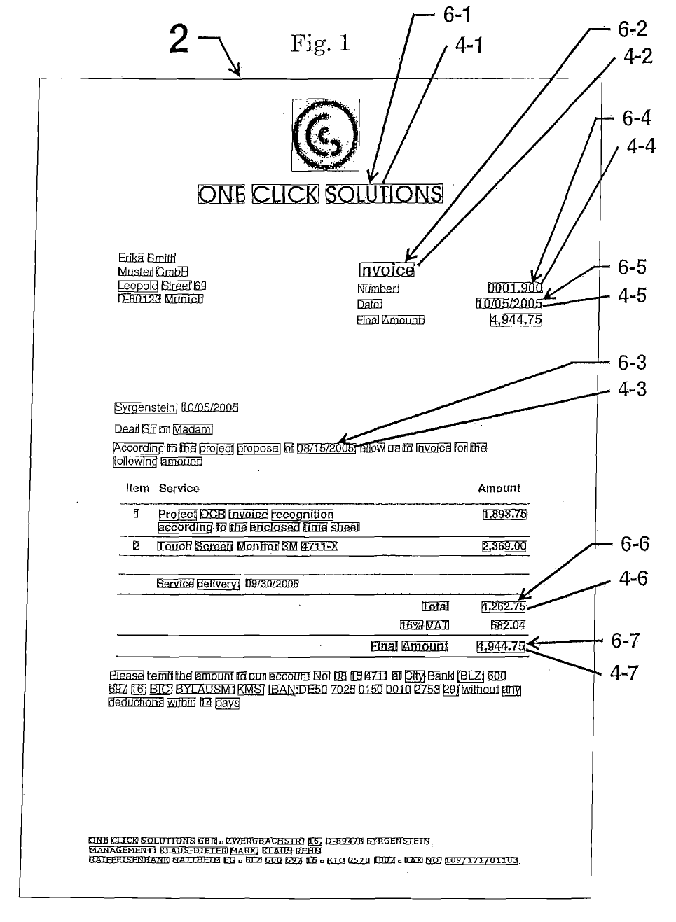

FIG. 1 shows a document 2, which is displayed on a monitor of a data processing device and which can be provided in the original or paper form.

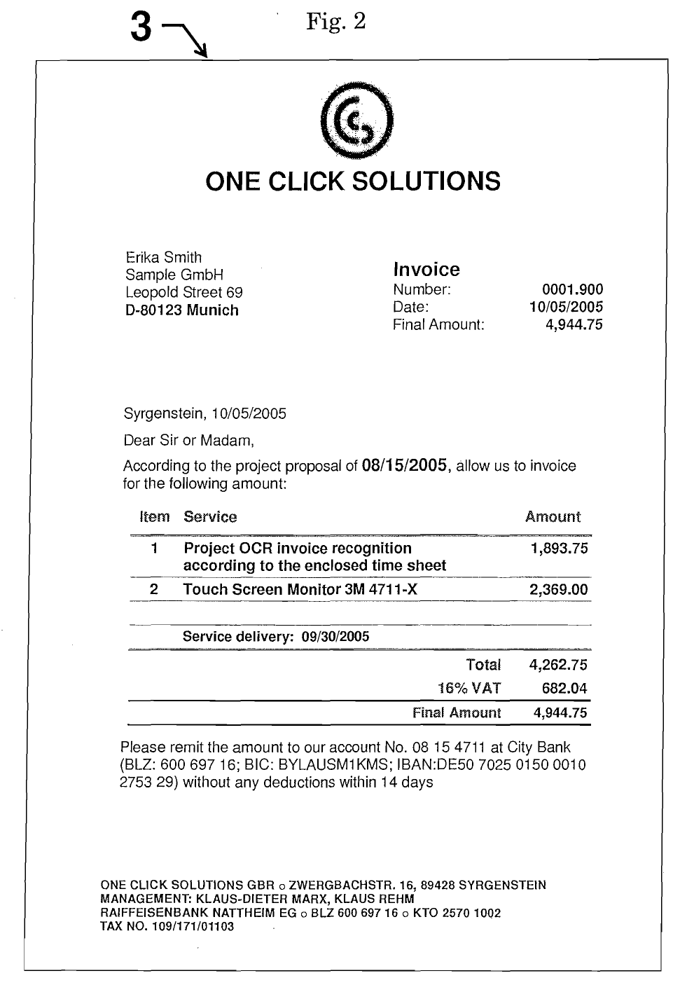

In the present embodiment, this document 2 involves an invoice. It can be provided, e.g., that the document 2 was transmitted to a customer or user in paper form. An original 3 of this document originally provided in paper form is shown in FIG. 2.

It is provided that the information typically recorded in writing on the original 3 or the associated data, in this case letters and numbers, will be recorded digitally. For this purpose, in a first step it is provided that the original 3 initially provided in paper form is read or scanned by a read-in device of a data processing device. With suitable programs, image information can be converted into a digital text.

Individual data 4, i.e., data 4-1, 4-2, 4-3, etc., from the image information will be processed in the conversion in such a way that the document 2 is displayed on a monitor of the data processing device such that individual document fields 6, i.e., 6-1, 6-2, 6-3, etc., are marked and thus emphasized visually, wherein a data unit 4 is allocated to each document field 6. Thus, the document 2 displayed on the monitor of the data processing device differs from its original 3 provided in paper form in such a way that document fields 6, which are now defined in the scope of the method and which include data 4 recorded during the reading, are marked, wherein a link between a data unit 4 and a document field 6 is prepared through a computer-assisted process of the reading. For the case that the document 2 was transmitted to the customer or in a scanned form as a PDF or TIFF format, the reading can comprise such preparation of the document 2, such that the initially graphical information is prepared in such a way that now individual data 4 is allocated to the document fields 6 and displayed in a very visible way.

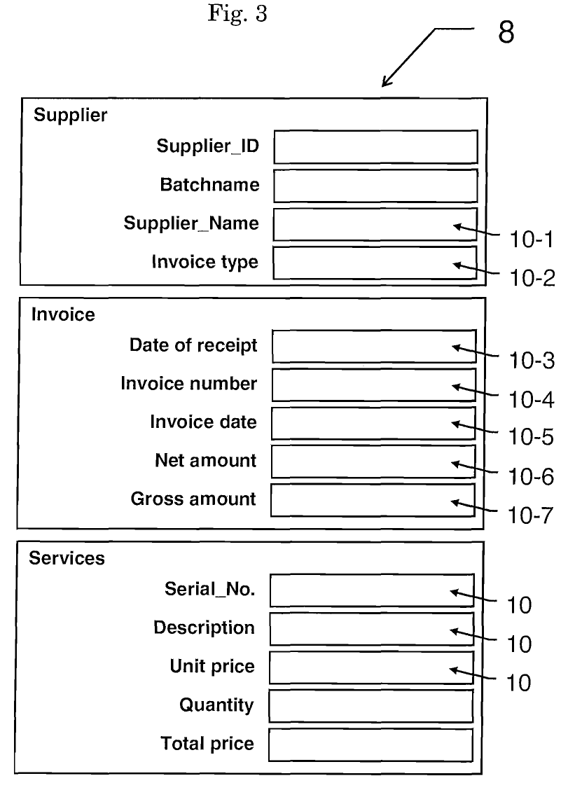

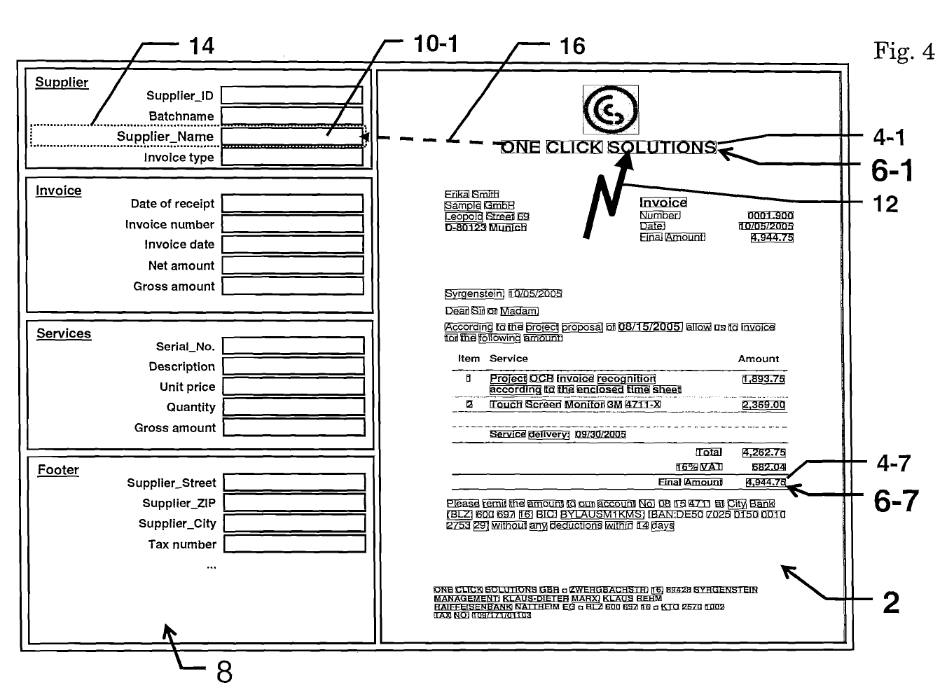

FIG. 3 shows a detailed data input mask 8, which can also be displayed like the marked document 2 on the monitor of the data processing device (cf. FIG. 4). This data input mask 8 comprises input fields 10, in which the data 4 from the document 2 is to be transmitted.

In previous methods for the acquisition of such data, it is provided that the data is read, in particular, from its original provided in paper form and input manually into corresponding input fields. With the present invention it is possible to improve this usually time-intensive and also error-susceptible process.

In the method for the acquisition of data 4 of the document 2 displayed on the monitor of the data processing device, wherein the data 4 of the document 2 is allocated to document fields 6, in the construction of the method described here it is provided that without restricting generality, each document field 4 is activated one after the other in a given sequence by means of an activation trigger unit not shown in more detail in FIG. 4, wherein the data 4 allocated to each of the activated document fields 6 is automatically recorded in each activated input field 10 of the data input mask 8 according to the given sequence. Accordingly, the input fields 10 are numbered continuously 10-1, 10-2, etc., analogous to the data 4 and the document fields 6.

Here, in the present embodiment, it is provided that the sequence is given in such a way that the data units are recorded one after the other into the input fields 10-1, 10-2, 10-3, 10-4, 10-5, 10-6, and 10-7. Here, the document fields 6-1, 6-2, 6-3, 6-4, 6-5, 6-6, and 6-7 must each be activated one after the other according to the given sequence by the activation trigger unit. It is also conceivable that a focus making the input fields 10 known as active can be shifted manually, so that individual input fields can also be selectively skipped. This can be important, e.g., if there are no relevant values for one or more input fields.

FIG. 4 now shows the moment, in which the current document field 6-1 to be activated, to which the data unit 4-1 is allocated, is activated with reference to the data input mask 8 of FIG. 3 and the document 2 of FIG. 1. Activation by the activation trigger unit is here shown schematically in FIG. 4 by the lightning-shaped arrow 12.

While the method is being performed, it is also provided that a focus 14 is displayed with functional and also display-specific properties on the data input mask 8. The focus 14 is here made known by a dashed-line box surrounding a corresponding input field. This focus 14 is constructed so that each input field 10 of the data input mask 8 to be activated and also to be marked or displayed visually in such a way that this input field 10 is activated. It is provided that each data unit 4 activated by means of the activation trigger unit is recorded automatically in each activated input field 10 provided for this data unit 4 and this input field 10 is then automatically deactivated. By means of the focus 14, after deactivation of each input field 10, a next input field 10 of the data input mask 8 is activated automatically. According to the given sequence, the input fields 10-1, 10-2, 10-3, 10-4, 10-5, 10-6, and 10-7 are thus activated automatically one after the other with the focus 14. In the present embodiment, the first input field 10-1 is currently activated by the focus 14. The activation of the first document field 6-1, which contains the data unit 4-1, which is to be allocated to the first input field 10-1, should be performed through single activation and through single charging of this first document field 6-1 by the activation trigger unit.

If the activation trigger unit is constructed as a computer mouse, then a single click on the first document field 6-1 by the computer mouse or by a pointer or cursor interacting with the computer mouse is sufficient. As shown schematically by the dashed-line arrow 16 in FIG. 4, when the first document field 6-1 is activated, the data unit 4-1 allocated to the first document field 6-1 is transmitted or copied automatically, so that this first data unit 4-1 is recorded, copied, or input into the first input field 10-1 of the data input mask 8. After successful registration of this first data unit 4-1, the first input field 10-1 is deactivated by the focus 14 and the second input field 10-2 (see FIG. 3) is activated automatically according to the given sequence.

For the case that several data units 4 from several document fields 6 are to be recorded in an input field 10 of the data input mask 8, it is possible that several document fields 6 are combined into a document field group. Accordingly, only one document field 6 of the document field group has to be activated. For this purpose, with the activation trigger unit all of the document fields 6 belonging to the document field group are selected together, triggered by the activation trigger unit, and in this way the data 4, which is allocated to the corresponding document fields 6 of the document field group, is recorded in the activated input field 10. In this way, each document field group, which comprises at least one document field 6, is activated by means of the activation trigger unit one after the other in the given sequence and the data 4 allocated to each activated document field group is recorded automatically into each activated input field 10 corresponding to the given sequence. The document field groups can comprise an arbitrary number of document fields 6. If a document field group comprises only one document field 6, this document filed 6 corresponds to the document field group, so that an activation of this one document field 6 corresponds to the activation of a document field group.

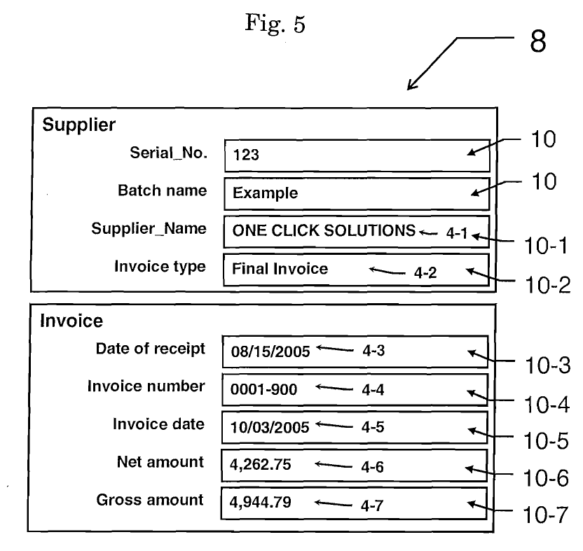

FIG. 5 shows a detail of the data input mask 8 from FIGS. 3 and 4 with input fields 10, in which the data 4 from the document 2 is already recorded or input according to the given sequence.

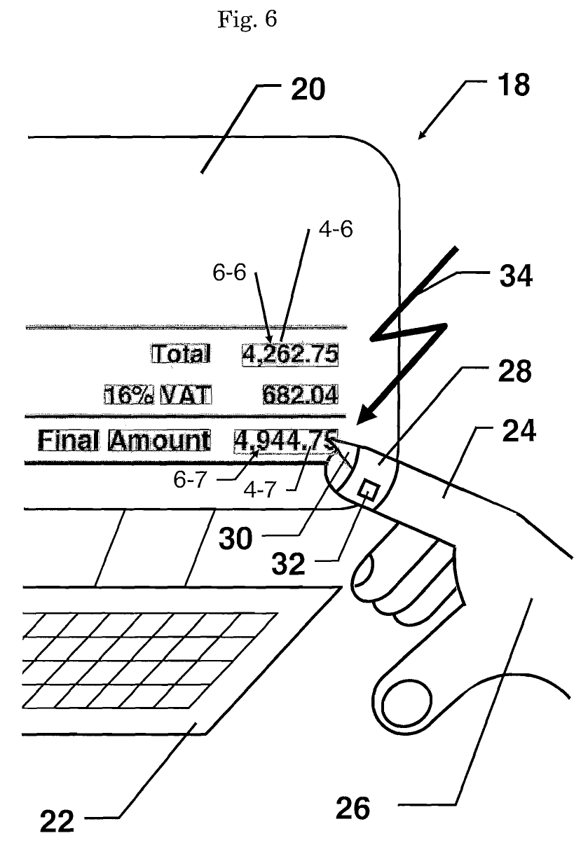

FIG. 6 shows in a schematic diagram a data processing device 18, which has a touch-sensitive monitor 20 and also a keyboard 22. FIG. 6 shows, in addition, a fingertip-shaped activation trigger unit 28 arranged on a finger 24 of a hand 26, wherein this activation trigger unit 28 has a contact element 30 and a switch 32. On the monitor 20 of the data processing device 18 there is an enlarged detail of the document 2 shown in FIGS. 1 and 4 shown with marked document fields 6, to which the data 4 is allocated.

In FIG. 6, the moment is shown, in which the seventh document field 6-7, to which the seventh data unit 4-7 is allocated, is activated by the activation trigger unit 28. This activation is realized here when the turned-on contact element 30 is turned off with a simultaneous touch on a surface of the touch-sensitive monitor 20 by the contact element 30 and is here shown schematically by a lightning-shaped arrow 34. The activation comprises a selection of at least one document field 6 by the activation trigger unit 28 with turned-on contact element 30 and a trigger of the activation trigger unit 28, in this case turning off the contact element 30. Here, this seventh data unit 4-7 is recorded into the seventh input field 10-7 of the data input mask 8 according to the given sequence.

In the present construction, a selection of each document field 6 or a document field group with several document fields 6, which is or are marked in the document 2 displayed on the monitor 20, can be turned on only when the contact element 30 of the activation trigger unit 28 is turned on. When the contact element 30 is turned off, an activation of the previously selected document fields is then performed automatically, which corresponds, in the transferring sense, to the “releasing” of the left mouse button for a computer mouse. The contact element 30 is turned on and off by a switch 32 of the activation trigger unit 28. For the case that the keyboard 22 of the data processing device 18 is to be operated by means of the finger 24, it is provided that the contact element 30 is to be turned off by corresponding activation of the switch 32. Now it is possible to operate the keyboard 22 with the finger 24 in an interrupt-free way, that is, without triggering functions of the activation trigger unit 28, even though the activation trigger unit 28 is still arranged on the finger. The fingertip-shaped activation trigger unit 28 thus does not have to be removed from the finger 24, because the contact element 30 is inactive in a turned-off state.

FIG. 7 shows an enlarged diagram of the activation trigger unit 28 presented in FIG. 6 with the contact element 30 arranged on this unit. The finger 24, on which the activation trigger unit 28 is placed, is here shown with dashed lines. The finger 24 passes through the activation trigger unit 28, so that a fingertip 36 of the finger 24 is located on each side of the activation trigger unit 28, on which the contact element 30 is also arranged. The activation trigger unit 28 has a cylindrical shape with an upper side 38 relative to the finger 24. The contact element 30 advantageously tapers to a point on the upper side 38 of the activation trigger unit 28 relative to the finger 24 such that small points can also be tapped or touched. The contact element 30 can here be arranged flush with the finger 24, in such a way that a clear view of the contact element 30 is guaranteed by a user.

Furthermore, the contact element 30 can be provided for a right-handed person on the upper side 38 on the left side of an axis lying in the center with respect to the upper side 38 or for a left-handed person on the upper side 38 on the right side of the axis lying in the center with respect to the upper side 38. In addition, the contact element 30 can be constructed as a short tip. Through the construction of the contact element 30 as a short tip, which is also arranged specific to the user on the upper side 38 on the right or left side of the axis lying in the center with respect to the upper side 38, a corresponding user can operate a normal keyboard without appreciable hindrance by the activation trigger unit 28, which does not have to be removed from the finger 24.

1. Method for the acquisition of data (4) of a document (2) displayed on a monitor (20) of a data processing device (18), comprising allocating the data (4) of the document (2) to marked document fields (6) and recording the data (4) allocated to the document fields (6) in input fields (10) of a data input mask (8), including activating each document field group one after the other in a given sequence by an activation trigger unit (28), and automatically recording at least one data unit (4) allocated to each activated document field group into each activated one of the input fields (10) according to the given sequence.

2. Method according to claim 1, wherein each document field group is activated so that at least one document field (6) is selected with the activation trigger unit (28) and is triggered by the activation trigger unit (28) and thus the one or more data units (4) allocated to the document field group is recorded into the activated input field (10).

3. Method according to claim 1, wherein only a current one of the input fields (10) of the data input mask (8) is activated by a focus (14), so that one or more units of the data (4) allocated to each document field group activated by the activation trigger unit (28) is automatically recorded in the activated input field (10) and the activated input field is then automatically deactivated, and in which then a next one of the input fields (10) of the data input mask (8) is activated automatically according to the given sequence by the focus (14).

4. Method according to claim 3, wherein the one or more data units (4) allocated to each of the activated document field groups is copied into the input field (10).

5. Method according to claim 1, wherein the sequence is defined by an arrangement of the input fields (10) on the data input mask (8).

6. Method according to claim 1, further comprising displaying the data input mask (8) on the monitor (20) of the data processing device (18).

7. Method according to claim 1, further comprising reading the document (2) by a read-in device of the data processing device (18), wherein each unit of the data (4) is allocated to a document field (6) and displaying the document (2) on the monitor (20) with the document fields (6) visibly marked.

8. Method according to claim 7, further comprising converting image information from the document (2) into digital text with the read-in device.

9. Method according to claim 1, further comprising initiating a correction routine if an unforeseen data unit (4) is allocated to one of the input fields (10).

10. Method according to claim 9, wherein one a unit of the data (4) is allocated to one of the input fields (10) by a keyboard (22) of the data processing device (18).

11. Data processing device comprising a monitor (20) and at least one activation trigger unit (28) and which is provided for the acquisition of data (4) of a document (2) displayed on the monitor (20) and which is constructed such that the data (4) of the document (2) is allocatable to marked document fields (6) and the data (4) allocated to the document fields (6) recordable in input fields (10) of a data input mask (8), wherein, with the at least one activation trigger unit (28), each document field group can be activated one after the other in a given sequence, wherein then at least one of the units of data (4) allocated to each activated one of the document field groups is automatically recorded into the input field (10) of the data input mask (8) activated according to the given sequence.

12. Data processing device according to claim 11, further comprising a pointer that is movable on the monitor (20) by the at least one activation trigger unit (28), wherein it is provided that with the pointer, at least one of the document fields (6) of the document field group can be selected and a selected one of the document fields (6) can be triggered by charging the at least one activation trigger units (28) and the units of the data (4) allocated to the document field can be recorded in the activated input field (10).

13. Data processing device according to claim 11, wherein the at least one activation trigger unit (28) is constructed as a computer mouse, by which the one or more document fields (6) of the document field group can be activated through a single click.

14. Data processing device according to claim 11, wherein the monitor (20) is touch-sensitive, and the at least one document field group displayed on the monitor (20) can be activated by touch.

15. Data processing device according to claim 11, wherein the at least one activation trigger unit (28) can be arranged on a finger (24) and has a contact element (30) that can be turned on and off, wherein for selecting the document field group the contact element (30) is turned on and the at least one document field (6) displayed on the monitor (20) is touched by the contact element (30) and the document field group comprising the at least one document fields (6) can then be triggered by turning off the contact element (30).

16. Data processing device according to claim 15, further comprising a keyboard (22), which can be operated with the finger (24), on which the one or more activation trigger units (28) is arranged.

17. Data processing device according to claim 11, further comprising has a scanning device for reading the document (2).

18. Activation trigger unit, which can be arranged on a finger (24), comprising a contact element (30) that can be turned on and off and which is constructed to activate a region displayed on a monitor (20) of a data processing device (18), the contact element (30) is turned on and one or more regions displayed on the monitor (20) are touched by the contact element (30) triggered by turning off the contact element (30).

19. Activation trigger unit according to claim 18, wherein a keyboard (22) of the data processing device (18) operates for the case that the contact element (30) is turned off.

20. Activation trigger unit according to claim 18, further comprising a switch (32) for turning the contact element (30) on and off.

21. Activation trigger unit according to claim 18, further comprising a transmission module constructed for exchanging signals with the data processing device (18).

22. Activation trigger unit according to claim 18, further comprising an attachment module for attachment of the activation trigger unit to a finger.

23. (canceled)

24. (canceled)
